(19) United States
(12) Patent Application Publication
(10) Pub. No.: US 2007/0208880 A1
(43) Pub. Date: Sep. 6, 2007

(54) Method for displaying image data

(75) Inventors: Eric Lauper, Bern (CH); Frederic Layani, Lausanne (CH)

Correspondence Address: PEARNE & GORDON LLP, 1801 EAST 9TH STREET, SUITE 1200, CLEVELAND, OH, 44114-3108, US

(73) Assignee: Swisscom Mobile AG, Bern (CH)

(21) Appl. No.: 11/800,179

(22) Filed: May 4, 2007

Related U.S. Application Data
(63) Continuation of application No. PCT/EP05/55658, filed on Oct. 31, 2005.

(30) Foreign Application Priority Data
Nov. 4, 2004 (EP) 04105510

(51) Int. Cl. G06F 15/16

(52) U.S. Cl. 709/246

(57) ABSTRACT

The invention relates to a method for displaying an image (3) or image data. The image (3) or the image data is/are adapted according to parameters established in the user device (1) and are displayed in the display (2) of the user device (1). The parameters can, for example, be dependent on the following variables or are determined by one or a combination of these variables: location or use of the user device (1), use of a service associated with the user device (1); time, date, time of day or season or a sensor (5) located inside the user device (1). The invention also relates to a hypertext server (8) with a dynamic page containing the image (3) or the image data.

### REFERENCE DATA

This application is a continuation of international patent application PCT 2005WO-EP055658 (WO06048415) filed on Oct. 31, 2005, claiming priority from European patent application 2004EP-105510 (EP1655931) of Nov. 4, 2004, the contents whereof are hereby incorporated by reference.

### FIELD OF THE INVENTION

The invention relates to a method for displaying an image or image data and to a hypertext server according to the independent claims.

### RELATED ART

In the prior art, there are many documents that relate to background images, logos or other electronic displays.

EP-A1-1199868 discloses a method for automatically selecting a background image in order to display it in a display of a mobile telephone. EP-A2-1215864 describes a method wherein the logo of a network operator is sent by means of a broadcast SMS to mobile telephones, adapted locally and displayed on the display of the mobile device as soon as location-related information is displayed.

Document US-A1-202/0132610 discloses a method and a device wherein a background image of a mobile telephone is adapted depending on a user-specific profile. A similar method is known from JP2002/345032. GB-A-2373977 describes a background image for a mobile telephone that is adapted at regular intervals. In this manner, an animated image is created.

The published patent application EP-A1-1424839 describes a method for generating graphical animations that are recorded by a camera of a mobile telephone. Patent application EP-A2-1011248 discloses a method for displaying background images in mobile telephones. A background image is downloaded from a computer, stored in the telephone and played a preset time on the display of the mobile telephone. As soon as an urgent message reaches the telephone, the message stops playing, if the message is of normal importance, it is displayed only after the time has lapsed.

A method for playing an image sequence in a mobile telephone is disclosed in patent U.S. Pat. No. 5,870,683. This occurs in a rest period of the mobile telephone, when no calls are made, for example when switching on the telephone, when the battery is charged or when the keyboard is locked.

International publication WO-A1-2004/057578 describes a logo or image for a mobile telephone that represents a mouth. The mouth is automatically adapted to an audio message so that the message is spoken by the mouth.

EP-A1-1396984 discloses a mobile device in which a parameter depending on external effects (temperature, noise, location etc.) is recorded, stored locally and an action is linked with this parameter. Basically, a computer program is executed in order to modify the design of the cover.

### REPRESENTATION OF THE INVENTION

It is an aim of the present invention to propose a method and a device that allow companies to promote themselves in an improved manner. Their word and/or figurative mark, their product, their name, their logo or their advertisement etc. are to remain better engraved in the memory of the customers and be more easily recognized by the customers. In general, the customers should remember the company in a better manner.

It is another aim of the present application to propose a method and a device with which the user of a user device is encouraged and accompanied in an agreeable manner in everyday life by the display of a logo or background image.

The aims are achieved according to the invention through a method for displaying an image or image data according to the independent method claim corresponding to the preamble of claim 1 in that the image or image data is/are remotely downloaded and displayed on the basis of automatically determined parameters from a server.

The aims are also achieved through a hypertext server with at least one dynamic page according to the independent device claim, wherein the image or the image data is adapted to each user individually on the basis of at least one automatically determined parameter.

Said image or image data in the present application relate to a logo or background image, i.e. for example a word and/or figurative mark or the logo of a company or company-specific products, names, advertisements or representations.

The hypertext server generates a logo or background image by accessing a database or another server in which at least parts of the logo or background image are available. In this manner, it is easily possible to display dynamically a HTML page. For this dynamic display, data stored in the user device from a graphical interface of an application software or elements of the graphical user interface can also be used for changing resp. adapting the logo or background image. A page that is for example retrieved by a certain browser could thus influence the logo. Logos or background images or at least parts thereof can also be stored in the user device and it is only in the user device that the hypertext page that is downloaded is completed individually with these logos or background images.

In the inventive method, a logo is advantageously determined dynamically and modified or adapted on the basis of the activity or the state of mind of the user or on environmental influences. In this fashion, the user is accompanied and entertained throughout the day in an agreeable manner since a logo will not always be repeated in the same way. Simultaneously, the company advertises in an original manner for itself and its products. The logo can for example depend on the following variables: location or use of the user device, use of a service associated with the user device; time, date, time of day or season or a sensor located inside the user device and recording data outside the mobile device. Such a sensor could also be connected with the user device over an interface working at close range (Bluetooth, ZigBee, WLAN, DECT, etc.) or over another interface (e.g. Internet connection). It is also possible to change only parts, or the colors or the design of the logo or background image. Companies that present their logo or trademarks in this manner advantageously remain better engraved in the memory of the user and the trademark is afforded a particular image.

Many embodiments are conceivable for the inventive method. It is thus possible to change the logo on the basis of a profile determined by the user. In order not to overtax or disturb the user, it should be possible to switch on and off the “changing logo” mode. The kind or type of user device can play a role in displaying a changing logo or the logo or background image could be displayed only in rest periods during which the user does not access a particular function or a particular service.

Regarding the design of the logo, a camera built in the user device or a sensor can use physical data or data concerning the user to change the logo. In order to create a better interactivity, the user could also choose himself logos or parts thereof that are to be displayed later. A provider will inform the user about new logos or background images at regular intervals.

### BRIEF DESCRIPTION OF THE FIGURES

The invention will be described in more detail on the basis of the attached figures, where

FIG. 1 shows a user device with a logo displayed in the display of the user device,

FIG. 2 represents a mobile telephone connected over a mobile radio network with a hypertext server as example of a user device, and

FIG. 3-5 show a user device with a logo displayed in the display of the user device, where the logo is designed differently in different figures on the basis of different events.

The same elements are referred to in the same manner in the different figures.

### WAYS OF EXECUTING THE INVENTION

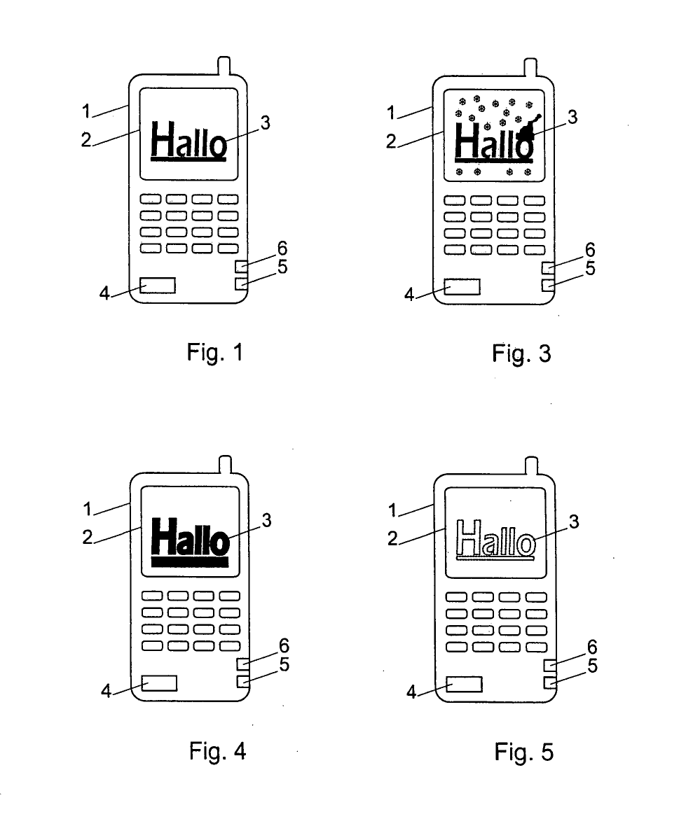

FIG. 1 shows a user device 1 with a display 2 in which an image 3 or image data is/are displayed. The image 3 or the image data concern in the present invention a logo or background image, a word and/or figurative mark or the logo of a company or company-specific products, names, advertisements or representations. Said user device 1 can be a computer, a portable computer, a PDA, a game terminal or another mobile device, preferably a mobile radio device, mobile telephone etc. The user device 1 can however also be a wristwatch in which a display is integrated. The display 2 can be fastened directly in the user device 1 or be connected with the user device 1. A retinal scanning display can for example be fastened to the frame of spectacles.

According to the inventive method, a particular logo or background image 3 is displayed in the display 2. This occurs in general during the application of a self-advertising company resp. on the page of the company or in the advertisement message or commercial of this company. Depending on the state of the user, on parameters determined in the user device 1 and/or on the basis of other external influences, a changed logo or background image 3 is then automatically determined. In the inventive method, the image 3 or the image data resp. the logo or the background image 3 are adapted individually to each user without the user's intervention.

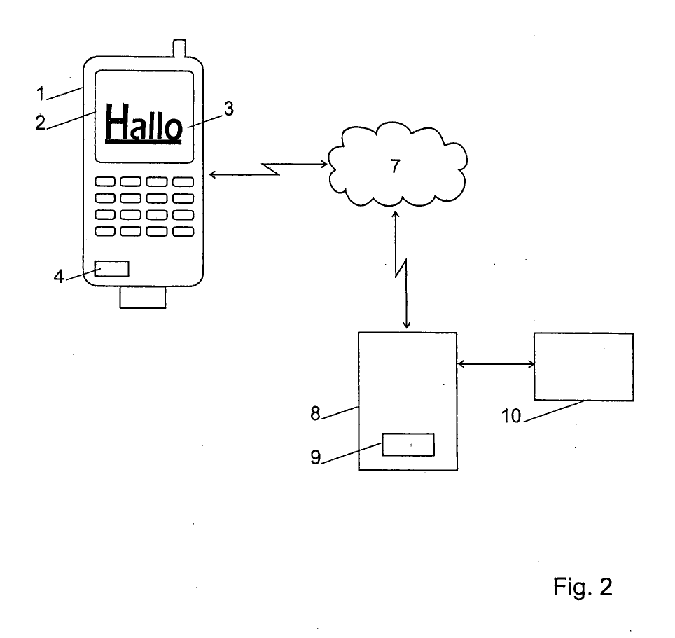

For different users that download and consult a page from a hypertext server 8, a different logo or background image 3 of the same company is displayed. This embodiment of the inventive method is explained with the aid of FIG. 2. The user device 1 in this case is a mobile radio device, for example a mobile telephone that is connected over a mobile radio network 7 with an inventive hypertext server 8. The mobile radio network 7 is for example a known GSM or UMTS radio network. A logo or background image 3 or parts thereof a stored in a database 9 representing part of the hypertext server 8. If a hypertext page of the hypertext server 8 is retrieved by the mobile radio device, certain parameters that will still be explained hereinafter are transmitted from the mobile radio device to the hypertext server 8. The hypertext page (html) contains dynamic parts that concern at least the changing logo 3. For this purpose, the hypertext server 8 is connected with a database 9 or another server 10 that makes available these parts of the changing logo 3 on the basis of the transmitted parameters. In a further embodiment, a logo 3 or parts thereof stored in the user device 1 and/or to be downloaded from the server are combined and used in the logo with other elements that are already available somewhere in the user device 1. The logo or background image 3 can thus advantageously respond to the current local applications or settings of the user device 1 and integrate them in the changing process. It is thus also possible to integrate data in the hypertext pages that extract information or elements from a graphical interface of an application software or from the graphical interface of the operating system (operating system GUI) and incorporate these in the page to be created. A page that is for example retrieved by a particular browser could thus influence the logo 3. In the hypertext server 8, the hypertext page is then completely prepared and then sent to the mobile telephone. The logo 3 is made available in a known file format jpeg, gif, png, as vector etc. It is also conceivable that the changing logos 3 or parts thereof are stored in the user device 1. For this purpose, a database 4 or a data memory is available in the mobile telephone 1 and the retrieved and downloaded hypertext page is completed individually only in the user device.

Said embodiment is however in no way limited to a mobile radio network 7 and to the devices connected thereto and represented in FIG. 2. A computer connected to the Internet and communicating with a hypertext server is also conceivable.

Said parameters are determined on the basis of functions or services accessed by the user during the operation of the user device 1. This does not mean simply accessing or executing a program but other activities performed by the user when using the device 1. The image 3 or the image data can be part of a game sequence in a game terminal, where the image attributes or image data attributes can be adapted on the basis of automatically determined parameters. For example, in the game sequence, advertising billboards are shown on the side of a road and their contents depend on the one hand by an advertiser and on the other hand by sensor data. The advertising billboards shown in the game can thus be adapted to the circumstances. The parameters can thus for example depend on the following variables or be determined by one or a combination of these variables: location or use of the user device, use of a service associated with the user device; time, date, time of day or season or a sensor located inside the user device 1 and recording data from the environment of the mobile device 1 or of the sensor 5. Such a sensor could also be connected with the user device over an interface working at close range (Bluetooth, ZigBee, WLAN, DECT, etc.) or over another interface (e.g. Internet connection) with the user device. The duration of a used service, or a special application such as the receiving of an e-mail or use of the integrated calendar can have an influence on said parameters.

In order to make the invention clearer, a changing logo is represented in FIGS. 1, 3 to 5 by way of example. A company trademark Hallo is first represented in the display 2 (FIG. 1). If an internal calendar observes that it is the beginning of winter or Christmas or if a sensor 5 measures an outside temperature below 0 degrees Celsius, a snow-covered Hallo is shown, which wears on the “o” a cap protecting it from the cold (FIG. 3). If the user of a mobile telephone over the course of a day makes many calls or writes many short messages or has been a lot on the move in town, which is detectable by an integrated location-determining system, i.e. if the user is rather active, a rubicund or red Hallo in bold letters is displayed (FIG. 4). If a value account connected with the user device or with a user identification module (e.g. a SIM module from the GSM world), not represented, for example a prepaid account, has been nearly used up and the renewal or loading has becoming urgently needed, a weak, nearly disappearing Hallo is displayed (FIG. 5). What is important in the present invention is that the change of the logo or background image 3 depends on the use, the user or the environment that is not pre-programmed but determined dynamically in the hypertext server 8 by accessing said server 10. It is possible, though not necessary, to exchange the whole logo or background image 3. It is also possible to change or adapt only parts, the colors or the individual design of the logo or background image 3, as shown in FIGS. 1 and 3 to 5. As logo or background image 3, animated image data such as cartons or comics are of course also suitable. A random change and adaptation of the logo or background image 3 depending on said variables is also conceivable.

The logo or background image 3 can be changed on the basis of a profile set by the user. The user can thus at least partly determine which or how many changes are acceptable. In order to avoid being disturbed, the user should be able to switch on and off the changing logo mode. The kind and type of the user device 1 can also play a role in designing a changing logo. It is thus conceivable that two users that perform the same activities with devices of a same manufacturer will receive different logos because they own another model of the manufacturer's. The logo or background image could be displayed only in rest periods during which the user does not access a particular function or a particular service.

The logo or background image 3 can also contain fully or partly images that have been recorded by a camera 6 built into the user device 1. If the previously mentioned sensor 5 records physical data such as air pressure, temperature, light irradiation etc., these data can be included and used for changing the logo, for example to create logos for summer days and winter nights. The same applies to data recorded by the sensor and which concern the user, such as for example blood pressure, pulse rate, blood saturation, skin temperature, etc.

A logo or background image 3 can be selected by the user from a list before it is downloaded. Such as service could be billed to the user and the user must pay for downloading a logo or a background image 3 or he is paid for this. The provider of a page informs the user of the user device 1 about new logos or background images 3 at regular intervals.

In the inventive method, a logo or background image 3 is advantageously determined dynamically and modified or adapted on the basis of the activity or the state of mind of the user or on environmental influences in the hypertext server 8 or in the user device 1. In this fashion, the user is accompanied and entertained throughout the day in an agreeable manner since a logo will not always be repeated in the same way. Simultaneously, the company advertises in an original manner for itself and its products

By analogy, the inventive method and the inventive device are also suitable for changing and reproducing sound data over a loudspeaker instead of image data over a display.

### REFERENCE LIST

1 User device
2 Display
3 Image, logo or background image
4 Database in the user device 1
5 Sensor in the user device 1
6 Camera in the user device 1
7 Mobile radio network
8 Hypertext server
9 Database in the server 7
10 Server

1. Method for displaying images or image data in the display of a plurality of user devices, the method having the following method steps:
an image or image data is/are adapted individually to each user without the user's intervention on the basis of at least one automatically determined parameter, and
displayed in the display of the user device of said user,
wherein the image or the image data is/are downloaded and displayed depending on parameters determined automatically from a server.

2. The method of claim 1, wherein as said image or image data, a logo or background image, i.e. a word and/or figurative mark or the logo of a company or company-specific products, names, advertisements or representations are displayed.

3. The method of claim 1, wherein at least one automatically determined parameter is transmitted from the user device to a hypertext server.

4. The method of claim 1, wherein the image or image data is/are available on a hypertext page and a different image is displayed to different users that download and look at the same page.

5. The method of claim 4, wherein the hypertext page is available on a hypertext server and the hypertext server generates an image or image data by accessing a database or another server in which at least part of the image is available.

6. The method of claim 4, wherein a further image, image data or parts thereof is/are stored in the user device and the downloaded hypertext page is completed individually in the user device with the stored image, image data or parts thereof.

7. The method of claim 1, wherein the images, image data or parts thereof are combined with a graphical interface of an application software or with elements of the graphical user interface of the user device.

8. The method of claim 1, wherein the image or the image data is/are adapted on the basis of
location or use of the user device,
use of a service associated with the user device,
time, date, time of day or season,
or a sensor located inside the user device or connected with the user device and recording data outside the mobile device, or
on the basis of a combination of said variables.

9. The method of claim 1, wherein only parts, the colors or the design of the same image or image data are changed or adapted.

10. The method of claim 1, wherein at least part of an image uses animated image data such as cartoons or comics.

11. The method of claim 1, wherein the image or the image data are changed or adapted randomly, depending on said parameters.

12. The method of claim 1, wherein the image or image data are changed on the basis of a profile set by the user.

13. The method of claim 1, wherein the image or image data are changed depending on the kind of user device.

14. The method of claim 1, wherein the image or image data contain at least partly images that have been recorded by a camera contained in the user device.

15. The method of claim 1, wherein an image or image data are selected by the user from a list.

16. The method of claim 1, wherein the user of the user device is informed by a provider about new images.

17. The method of claim 1, wherein the image or image data are displayed only in rest periods during which the user does not access any function or service.

18. The method of claim 1, wherein as user device a mobile device, preferably a mobile telephone, a portable computer, a game terminal or a PDA is used.

19. The method of claim 1, wherein a mode in which the displaying of the image or image data is changed or adapted according to claim 1 is switched on or off in the user device.

20. Hypertext server with at least one dynamic page containing an image or image data, where the image or the image data are adapted individually to each user on the basis of at least one automatically determined parameter.

21. The hypertext server of claim 20, wherein the dynamic page as said image or image data contains a logo or background image, i.e. a word and/or figurative mark or the logo of a company or company-specific products, names, advertisements or representations.

22. The hypertext server of claim 20, wherein the image or image data of the dynamic page can be adapted on the basis of
location or use of the user device,
use of a service associated with the user device,
time, date, time of day or season,
or a sensor located inside the user device or connected with the user device and recording data outside the mobile device, or
on the basis of a combination of said variables.

23. The hypertext server of claim 20, wherein the hypertext server is connected with a database or another server in which at least part of the image or image data is available.
